(19) United States
(12) Patent Application Publication
(10) Pub. No.: US 2026/0012493 A1
(43) Pub. Date: Jan. 8, 2026

(54) FRIENDLY OPERATION OF AN IP MULTIMEDIA SUBSYSTEM OF A COMMUNICATION NETWORK

(71) Applicant: Deutsche Telekom AG, Bonn (DE)

(72) Inventors: Roland SCHOTT, Bad Nauheim (DE); Taoufik BOUSSOUAB, Frankfurt am Main (DE); Roland JESSKE, Laudenbach (DE)

(21) Appl. No.: 19/130,584

(22) PCT Filed: Nov. 10, 2023
(86) PCT No.: PCT/EP2023/081414

§ 371 Date: May 16, 2025

(30) Foreign Application Priority Data
Nov. 24, 2022 (EP) 22209480.7

(51) Int. Cl. H04L 65/1073; H04L 65/1016; H04L 65/1045; H04L 65/1069; H04L 65/1104

(52) U.S. Cl. CPC H04L 65/1073; H04L 65/1016; H04L 65/1045; H04L 65/1069; H04L 65/1104

(57) ABSTRACT

A method for operating an IP multimedia subsystem (IMS) of a communication network includes: a stateless application server (AS) of the IMS of the communication network receives a communication request from a terminal device relayed by a communication network entity of the IMS; the stateless AS provides the terminal device with a requested communication connection and increases a current value of a central concurrent calls counter associated with the terminal device and stored by a database of the communication network when the current value of the central concurrent calls counter is smaller than a maximum number of simultaneous communications allowed for the terminal device by the communication network; and the stateless AS provides the terminal device with the requested communication connection when the current value of the central concurrent calls counter equals the defined maximum number.

### CROSS-REFERENCE TO PRIOR APPLICATIONS

This application is a U.S. National Phase application under 35 U.S.C. § 371 of International Application No. PCT/EP2023/081414, filed on Nov. 10, 2023, and claims benefit to European Patent Application No. EP 22209480.7, filed on Nov. 24, 2022. The International Application was published in English on May 30, 2024 as WO 2024/110217 A1 under PCT Article 21 (2).

### FIELD

The invention relates to a method for operating an internet protocol (IP) multimedia subsystem (IMS) of a communication network, wherein a stateless application server (AS) of an IMS of a communication network receives a communication request from a terminal device relayed by a network entity of the IMS; the stateless AS provides the terminal device with a requested communication connection and increases a current value of a central concurrent calls counter associated with the terminal device and stored by a database of the communication network when the current value of the central concurrent calls counter is smaller than a maximum number of simultaneous communications allowed for the terminal device by the communication network. The invention further relates to a stateless AS for an IMS of a communication network, an IMS for a communication network, and a computer program product.

### BACKGROUND

A communication network usually allows a respective maximum number of simultaneous communication connections for each terminal device, i.e., user equipment (UE). Each communication connection is provided by a stateless AS of an IMS of the communication network. The stateless AS receives a communication request of a terminal device and provides the terminal device with a requested communication connection when a current number of allowed simultaneous communication connections provided for the terminal device including the requested communication connection does not exceed the allowed maximum number. Otherwise, the stateless AS declines the requested communication connection.

The current number of allowed simultaneous communication connections is centrally stored by the database and accessed by the stateless AS. The current number is implemented as a value of the central concurrent calls counter. The stateless AS increases the current number for each provided communication connection and decreases the current number for each terminated communication connection. Thus, the central concurrent calls counter keeps track of the allowed simultaneous communication connections of the terminal device.

However, communication connections of the terminal device may terminate abnormally preventing the stateless AS from decreasing the value of the central concurrent calls counter. As a consequence, the stateless AS wrongly declines a communication request of the terminal device when the central concurrent calls counter equals the maximum number of allowed simultaneous communication connections.

### SUMMARY

In an exemplary embodiment, the present invention provides a method for operating an IP multimedia subsystem (IMS) of a communication network. The method includes: a stateless application server (AS) of the IMS of the communication network receives a communication request from a terminal device relayed by a communication network entity of the IMS; the stateless AS provides the terminal device with a requested communication connection and increases a current value of a central concurrent calls counter associated with the terminal device and stored by a database of the communication network when the current value of the central concurrent calls counter is smaller than a maximum number of simultaneous communications allowed for the terminal device by the communication network; and the stateless AS provides the terminal device with the requested communication connection when the current value of the central concurrent calls counter equals the defined maximum number and another network entity of the IMS having previously relayed a communication connection for the terminal device, upon an alive request of the stateless AS, confirms a termination of the previously relayed communication connection.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows an entity diagram of an IMS according to an embodiment of the invention for a communication network.

### DETAILED DESCRIPTION

Exemplary embodiments of the invention provide a method for operating an IP multimedia subsystem of a communication network which does not wrongly decline a communication request of a terminal device. Exemplary embodiments of the invention further provide a stateless AS for an IMS of a communication network, an IMS for a communication network, and a computer program product.

In an exemplary embodiment, the invention provides a method for operating an IP multimedia subsystem (IMS) of a communication network, wherein a stateless application server (AS) of an IMS of a communication network receives a communication request from a terminal device relayed by a network entity of the IMS; the stateless AS provides the terminal device with a requested communication connection and increases a current value of a central concurrent calls counter associated with the terminal device and stored by a database of the communication network when the current value of the central concurrent calls counter is smaller than a maximum number of simultaneous communications allowed for the terminal device by the communication network. The communication request and the communication connection of the terminal device is relayed by the network entity to the stateless AS. The stateless AS ensures that the terminal device is provided with simultaneous communication connections until the maximum number of simultaneous communication connections has been reached.

The communication network may be a fixed-line network or a cellular network. The concurrent calls counter may be a generic connection admission control (GCAC) counter. The database may be a user profile database or a network data layer (NDL).

According to the invention, the stateless AS provides the terminal device with the requested communication connection when the current value of the central concurrent calls counter equals the defined maximum number and another network entity of the IMS having previously relayed a communication connection for the terminal device, upon an alive request of the stateless AS, confirms a termination of the previously relayed communication connection. In other words, the stateless AS checks a status of a previous communication connection previously relayed by another network entity. The status is checked via the alive request.

The communication request can be accepted despite the current value of the central concurrent calls counter equaling the maximum number of simultaneous connections when the previous communication connection has been abnormally terminated, i.e. without the knowledge of the stateless AS and without decreasing the current value of the central concurrent calls counter.

Confirming may comprise not answering the alive request. The alive request triggers an answer of the other network entity. The other network entity does not answer when the previously relayed communication connection has been terminated.

Preferably, the stateless AS declines the requested communication connection when the current value of the central concurrent calls counter equals the defined maximum number and the other network entity, upon the request of the stateless AS, negates the termination of the previously relayed communication connection. The communication request cannot be accepted when the previous communication connection keeps on being used by the terminal device.

Negating may comprise answering the alive request. The other network entity answers the alive request when the previously relayed communication connection is still in use.

The stateless AS advantageously transmits a session information protocol, SIP, options request to the other network entity as the alive request. The SIP is specified by RFC 3261 and defines a plurality of requests comprising the options request.

The other network entity may confirm the termination of the previously relayed communication connection when the previously relayed communication connection was aborted without receiving a SIP bye request from the terminal device. The SIP bye request normally terminates the communication connection. A missing SIP bye request indicates an abort of the communication connection, i.e. an abnormal termination.

In an embodiment, the terminal device requests a VoIP call connection as the communication connection. VoIP calls are common communication connections provided by the IMS and are used for telephone calls executed via the terminal device. The terminal device may be configured as a stationary terminal device or as a mobile terminal device, e.g., a smartphone, a tablet, a smartwatch and the like.

A first proxy call session control function (P-CSCF) of the network entity may relay the communication request. A second P-CSCF of the other network entity may confirm or negate the termination of the previously relayed communication connection. Thus, a sudden change of the P-CSCF due to a physical movement of the terminal device or due to a P-CSCF redundancy does not result in wrongly declining the communication request of the terminal device.

Another aspect of the invention is a stateless AS for an IMS of a communication network. The stateless AS provides a terminal device with a communication connection.

The stateless AS is configured for carrying out a method according to the invention. The stateless AS does not wrongly decline communication requests of the terminal device.

A third aspect of the invention is an IMS for a communication network, comprising a stateless AS. The IMS controls communication connections of terminal devices.

According to the invention, the IMS comprises a stateless AS according to an embodiment of the invention. The IMS friendly controls the communication connections.

A fourth aspect of the invention is a computer program product, comprising a storage medium storing a program code. The storage medium may be configured as a CD (compact disc), a DVD (digital versatile disk), a USB (universal serial bus) stick, a hard drive, a RAM (random access memory) chip, a cloud storage and the like.

According to the invention, the program code causing a computing device to carry out a method according to an embodiment of the invention as a stateless AS of an IMS when being executed by a processor of the computing device. The computer program product implements an inventive AS.

An advantage of the inventive method is that the IP multimedia subsystem of a communication network does not wrongly decline a communication request of a terminal device. As a consequence, a customer's satisfaction in using the terminal device is increased.

It shall be understood that the features described previously and to be described subsequently may be used not only in the indicated combinations but also in different combinations or on their own without leaving the scope of the present invention.

The invention is described in detail via an exemplary embodiment and with reference to the drawing. Like components are indicated by like reference numerals throughout the drawing.

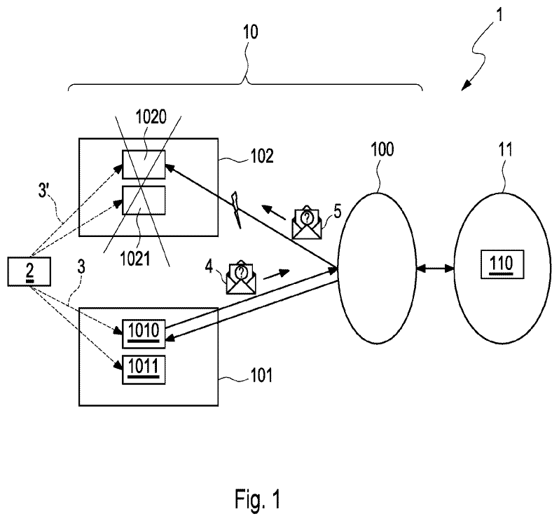

FIG. 1 schematically shows an entity diagram of an IP multimedia subsystem (IMS) 10 according to an embodiment of the invention for a communication network 1. The communication network may be a fixed-line network or a cellular network.

The IMS 10 comprises a stateless application server (AS) 100 according to an embodiment of the invention for the IMS 10. The IMS 10 may additionally comprise a network entity 101 and another network entity 102. The network entity 101 may comprise a first proxy call session control function (P-CSCF) 1010 and a first access border function 1011. The other network entity 102 may comprise a second P-CSCF 1020 and a second access border function 1021.

The stateless AS 100 is configured for carrying out a method according to an embodiment of the invention as described below. The stateless AS 100 may be implemented via a computer program product comprising a storage medium storing a program code. The program code causes a computing device to carry out a method according to an embodiment of the invention as the stateless AS 100 of the IMS of the communication network when being executed by a processor of the computing device.

The method is applied for operating the IMS 10 of the communication network 1. The stateless AS 100 of the IMS 10 of the communication network 1 receives a communication request 4 from a terminal device 2. The terminal device 2 may be configured as a stationary terminal device or as a mobile terminal device, e.g., a smartphone, a tablet, a smartwatch and the like.

The terminal device 2 may request a VoIP call connection as the communication connection. The communication request 4 is relayed by a network entity 101 of the IMS 10. The first P-CSCF 1010 of the network entity 101 may relay the communication request 4.

The stateless AS 100 provides the terminal device 2 with a requested communication connection 3 and increases a current value of a central concurrent calls counter 110 associated with the terminal device 2 and stored by a database 11 of the communication network 1 when the current value of the central concurrent calls counter 110 is smaller than a maximum number of simultaneous communications allowed for the terminal device 2 by the communication network 1. The concurrent calls counter may be a generic connection admission control (GCAC) counter. The database may be a user profile database or a network data layer (NDL).

The stateless AS 100 also provides the terminal device 2 with the requested communication connection 3 when the current value of the central concurrent calls counter 110 equals the defined maximum number and another network entity 102 of the IMS 10 having previously relayed a communication connection 3′ for the terminal device 2, upon an alive request 5 of the stateless AS 100, confirms a termination of the previously relayed communication connection 3′. Confirming may comprise not answering the alive request 5.

The stateless AS 100 may alternatively decline the requested communication connection 3 when the current value of the central concurrent calls counter 110 equals the defined maximum number and the other network entity 102, upon the alive request 5 of the stateless AS 100, negates the termination of the previously relayed communication connection 3′. Negating may comprise answering the alive request 5.

The stateless AS 100 preferably transmits a session information protocol (SIP) options request to the other network entity 102 as the alive request 5. The second P-CSCF 1020 of the other network entity 102 may confirm or negate the termination of the previously relayed communication connection 3′.

Particularly, the other network entity 102 confirms the termination of the previously relayed communication connection 3′ when the previously relayed communication connection 3′ was aborted without receiving a SIP bye request from the terminal device 2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE NUMERALS

1 communication network
10 IP multimedia subsystem
100 stateless application server
101 network entity
1010 first proxy call session control function
1011 first access border function
102 other network entity
1020 second proxy call session control function
1021 second access border function
11 database
110 central concurrent calls counter
2 terminal device
3 communication connection
3′ previously relayed communication connection
4 communication request
5 alive request

1-12. (canceled)

13. A method for operating an IP multimedia subsystem (IMS) of a communication network, comprising:
a stateless application server (AS) of the IMS of the communication network receives a communication request from a terminal device relayed by a communication network entity of the IMS;
the stateless AS provides the terminal device with a requested communication connection and increases a current value of a central concurrent calls counter associated with the terminal device and stored by a database of the communication network when the current value of the central concurrent calls counter is smaller than a maximum number of simultaneous communications allowed for the terminal device by the communication network; and
the stateless AS provides the terminal device with the requested communication connection when the current value of the central concurrent calls counter equals the defined maximum number and another network entity of the IMS having previously relayed a communication connection for the terminal device, upon an alive request of the stateless AS, confirms a termination of the previously relayed communication connection.

14. The method according to claim 13, wherein the confirming comprises not answering the alive request.

15. The method according to claim 13, wherein the stateless AS declines the requested communication connection when the current value of the central concurrent calls counter equals the defined maximum number and the other network entity, upon the alive request of the stateless AS, negates the termination of the previously relayed communication connection.

16. The method according to claim 15, wherein the negating comprises answering the alive request.

17. The method according to claim 13, wherein the stateless AS transmits a session initiation protocol (SIP) options request to the other network entity as the alive request.

18. The method according to claim 13, wherein the other network entity confirms the termination of the previously relayed communication connection when the previously relayed communication connection was aborted without receiving an SIP bye request from the terminal device.

19. The method according to claim 13, wherein the terminal device requests a VoIP call connection as the communication connection.

20. The method according to claim 13, wherein a first proxy call session control function (P-CSCF) of the network entity relays the communication request.

21. The method according to claim 13, wherein a second proxy call session control function (P-CSCF) of the other network entity confirms or negates the termination of the previously relayed communication connection.

22. A stateless application server (AS) for an IP multimedia subsystem (IMS) of a communication network, configured for carrying out the method according to claim 13.

23. An IP multimedia subsystem (IMS) for a communication network, comprising the stateless application server (AS) according to claim 22.

24. A computer program product, comprising a storage medium storing a program code, the program code causing a computing device to carry out the method according to claim 13 as a stateless application server (AS) of an IP multimedia subsystem (IMS) of a communication network when being executed by a processor of the computing device.
